(19) United States
(12) Patent Application Publication
(10) Pub. No.: US 2026/0185896 A1
(43) Pub. Date: Jul. 2, 2026

(54) ACTIVE WAVE ABSORPTION DEVICE AND METHOD FOR WAVE MAKER PADDLES IN LARGE-SCALE EXPERIMENTAL BASIN

(71) Applicant: Tianjin University, Tianjin (CN)

(72) Inventors: Zhigang Bai, Tianjin (CN); Xuebing Zhang, Tianjin (CN); Qinghua Han, Tianjin (CN); Xiang Yan, Tianjin (CN); Pengfei Fu, Tianjin (CN); Xihan Wang, Tianjin (CN); Feiran Song, Tianjin (CN)

(21) Appl. No.: 19/228,667

(22) Filed: Jun. 4, 2025

(30) Foreign Application Priority Data
Dec. 30, 2024 (CN) 202411962264.5

(51) Int. Cl. G01M 10/00

(52) U.S. Cl. CPC G01M 10/00

(57) ABSTRACT

The present disclosure provides an active wave absorption device and method for wave maker paddles in a large-scale experimental basin. The device includes: wave maker paddles (1), push board mounting frames (2), a motion controller (5), synchronous belt drive assemblies (6) and drive piece mounting frames. When the synchronous belt drive assembly operates under the control of the motion controller, the push board mounting frame is driven, realizing horizontal movement; the wave maker paddle is fixed to a front end of the push board mounting frame, and moves with the push board mounting frame, realizing wave generation; and the motion controller is controlled according to a governing equation of the wave maker paddle determined in two domains: time domain and frequency domain. According to the present disclosure, the challenge of wave reflection in a fully three-dimensional experimental basin can be addressed, ensuring simulation precision of waves.

### CROSS-REFERENCE TO RELATED APPLICATION

This application claims priority of Chinese Patent Application No. 202411962264.5, filed on Dec. 30, 2024, the entire contents of which are incorporated herein by reference.

### TECHNICAL FIELD

The present disclosure belongs to the technical field of water engineering, and specifically to an active wave absorption device and method for wave maker paddles in a large-scale experimental basin.

### BACKGROUND

With the proposal of a maritime power strategy, research on ports, coasts, ship performance, and other related fields has become a hot topic, all of which fundamentally rely on high-precision wave physical modeling test environments. In natural marine environments, waves encounter reflection from structures during propagation, thereby directly propagating to the infinite open ocean, without causing secondary interference to the structures. However, during physical modeling experiments, the limited boundary range of the experimental basin causes waves generated by the wave generation equipment to reflect off the boundaries of the basin. These reflected waves interfere and superimpose with the original incident waves, undermining the effectiveness of the experimental simulation. Existing wave absorption methodologies can be categorized into passive wave absorption techniques and quasi-three-dimensional active absorption techniques based on operational principles.

Passive wave dissipation facilities are often arranged at a terminal end of a basin, utilizing specific materials or structural forms. When waves propagate to the passive wave dissipation facility, the waves break, dissipating the energy of the incident waves, thereby reducing reflection. Passive wave absorption techniques have certain effects in wave absorption, but there are some shortcomings.

(1) High maintenance costs: wave absorption structures may be affected by waves, currents and corrosion during use, requiring regular maintenance and replacement, thereby increasing operating costs.

(2) Poor wave absorption performance: traditional passive wave absorption devices usually employ a single structural form, leading to a poor wave absorption effect when dealing with long-period waves and high-energy waves.

(3) Space occupation: the wave absorption structure needs to occupy a certain amount of basin space, which affects the actual use area of the basin, thereby limiting the actual use efficiency of the basin.

Based on the idea of generating compensated waves, the quasi-three-dimensional active absorption techniques establishes a relationship between wave signals fed by sensors and motions of wave maker paddles. It is considered that the motion displacement of the wave maker paddles can be regarded as the superposition of the motion displacement of the wave maker paddles that generate incident waves and the motion displacement of the wave maker paddles that absorb secondary reflected waves. This technique assumes that a reflected wave angle is a known and fixed angle to actively eliminate the reflection of the wave. Existing shortcomings are as follows:
(1) application limitations: the quasi-three-dimensional active absorption techniques assume that the reflected wave angle is a known and fixed angle. However, in practical applications, the reflected wave angle is constantly changing. This assumption of a fixed angle limits the range of applications and can only compensate for a single angle of reflected waves, making it difficult to handle complex multi-angle reflected wave fields; and
(2) poor real-time performance: the preset angle of the reflected wave is plugged into a three-dimensional hydrodynamic transfer function to calculate a theoretical displacement of the wave maker paddles under different direction-of-arrival (DOA) angles, making it impossible to determine DOA in real time to correct the motion of the wave maker paddles.

### SUMMARY

The present disclosure aims to solve at least one of the technical problems in the above related art to a certain extent.

An objective of the present disclosure is to provide an active wave absorption device and method for wave maker paddles in a large-scale experimental basin, which can solve the problem of wave reflection in a fully three-dimensional experimental basin, ensuring simulation precision of waves.

To solve the above technical problems, the present disclosure is realized as follows.

An embodiment of the present disclosure provides an active wave absorption device for wave maker paddles in a large-scale experimental basin, including wave maker paddles 1, push board mounting frames 2, a motion controller 5, synchronous belt drive assemblies 6 and drive piece mounting frames;
the drive piece mounting frame is horizontally arranged, one end is fixed to a wall of an experimental basin, and the other end is in a free state; and the synchronous belt drive assembly 6 is arranged on the drive piece mounting frame and connected to the motion controller 5; and
the push board mounting frame 2 is arranged below the drive piece mounting frame and fixedly connected to the synchronous belt drive assembly 6; when the synchronous belt drive assembly 6 operates under the control of the motion controller 5, it drives the push board mounting frame 2 to realize horizontal movement; and the wave maker paddle 1 is fixed to a front end of the push board mounting frame 2, and moves with the push board mounting frame 2, realizing wave absorption and generation.

In addition, according to the active wave absorption device for wave maker paddles in a large-scale experimental basin of the present disclosure, the following additional technical features are included.

In some embodiments, the device further includes a plurality of laser sensors 3, a plurality of ultrasonic sensors 4, and an upper computer;
the laser sensor 3 is arranged at an upper portion of a front surface of the wave maker paddle, and at least one laser sensor is arranged on each wave maker paddle;
the ultrasonic sensors 4 are arranged on forward extension lines of the drive piece mounting frames, the plurality of ultrasonic sensors 4 extend forward by different lengths, ensuring that the ultrasonic sensors 4 are arranged in an alternating configuration; and
the upper computer is connected to the laser sensors 3 and the ultrasonic sensors 4, and used for calculating a governing equation of the wave maker paddles based on information collected by the laser sensors 3 and the ultrasonic sensors 4.

In some embodiments, the synchronous belt drive assembly 6 includes a servo motor, a driving wheel, a driven wheel, and a synchronous belt with connecting teeth arranged on an inner side; and
a motor shaft of the servo motor is fixedly connected to the driving wheel, one end of the synchronous belt is meshed with the driving wheel, and the other end is meshed with the driven wheel;
the driving wheel rotates, driving the synchronous belt and the driven wheel to rotate; and the synchronous belt is fixedly connected to the push board mounting frame 2, driving the push board mounting frame 2 to achieve displacement.

In some embodiments, guide rail sliding blocks are arranged at a top of the push board mounting frame 2, a corresponding horizontal guide rail is arranged on a lower surface of the drive piece mounting frame, and the guide rail sliding blocks are slidably connected to the guide rail; and when the push board mounting frame 2 is driven to displace back and forth, the wave maker paddle 1 connected to the push board mounting frame 2 moves back and forth simultaneously, generating push-pull forces on water to achieve wave generation.

In some embodiments, the upper computer performs calculation from two domains of time domain and frequency domain based on the information collected by the laser sensors 3 and the ultrasonic sensors 4, to determine the governing equation of the wave maker paddles.

In some embodiments, the upper computer is used for calculating a main direction of a reflected wave field by using a direction angle algorithm based on the information collected in real time, and determining the governing equation of the wave maker paddles based on the main direction.

In some embodiments, the collected information includes amplitude, frequency and DOA.

In some embodiments, the push board mounting frame 2 is a triangular stainless steel truss.

In some embodiments, two guide rail sliding blocks are arranged at the tops of each push board mounting frame 2, and matched with two guide rails.

An embodiment of the present disclosure further provides an active wave absorption method for wave maker paddles in a large-scale experimental basin, utilizing the active wave absorption device for wave maker paddles in a large-scale experimental basin as described in any one of the preceding items; and
the method includes the steps of performing calculation from two domains of time domain and frequency domain based on information collected by sensors in real time, to determine a governing equation of wave maker paddles, sending real-time control signals to a motion controller 5 based on the governing equation, controlling movements of synchronous belt drive assemblies 6 through the motion controller 5, and driving the corresponding wave maker paddle 1 to move to achieve wave generation.

Compared to the related art, the present disclosure has the following beneficial effects.

In the embodiment of the present disclosure, the provided active wave absorption device for wave maker paddles in a large-scale experimental basin ensures that the wave maker paddles can move flexibly and generate waves through square structures of the wave maker paddles and connection mode with the push board mounting frames. The strategic placement and quantity of laser sensors and ultrasonic sensors ensure that wave signals can be accurately collected in real time. Furthermore, the coordinated operation between the motion controller and synchronous belt drive assemblies achieves precise control of the wave maker paddle motion.

In the embodiment of the present disclosure, the provided active wave absorption device for wave maker paddles in a large-scale experimental basin can determine the control mode of the wave maker paddles from two perspectives of time domain and frequency domain in a combined manner, ensuring effective wave absorption under various conditions. With the introduction of the direction angle algorithm, compensation for multi-angle reflected waves can be achieved by calculating directions of reflected waves in real time.

In the embodiment of the present disclosure, the provided active wave absorption device for wave maker paddles in a large-scale experimental basin can collect data in real time through the laser sensors and the ultrasonic sensors, ensuring the accuracy and real-time performance of wave signals. The motion controller can adjust the displacement increment of the wave maker paddles in real time based on the wave signals fed back by the sensors, combined with an active absorption algorithm, to achieve dynamic compensation. Motion phase differences of a plurality of wave maker paddles are utilized to achieve oblique wave generation, generate compensation waves, and ultimately realize full three-dimensional active absorption wave generation.

The active wave absorption method for wave maker paddles in a large-scale wave basin of the present disclosure is implemented through the active wave absorption devices for wave maker paddles in a large-scale wave basin, thereby incorporating at least all features and advantages of the active wave absorption devices for wave maker paddles in a large-scale wave basin, obviating redundant technical elaboration herein. Additional aspects and advantages of the present disclosure will be partially presented in the following description, while others will become obvious from the following description, or be learned by the practice of the present disclosure.

### BRIEF DESCRIPTION OF THE DRAWINGS

FIG. 1 is a schematic structural diagram of an active wave absorption device for wave maker paddles in a large-scale experimental basin according to an embodiment of the present disclosure;

FIG. 2 is a schematic diagram showing signal reception by a single-source linear array using a direction angle algorithm according to an embodiment of the present disclosure; and

FIG. 3 is a schematic diagram showing a multi-board oblique wave generation according to an embodiment of the present disclosure.

Reference numerals and denotations thereof:
1—wave maker paddle; 2—push board mounting frame; 3—laser sensor; 4—ultrasonic sensor; 5—motion controller; and 6—synchronous belt drive assembly.

### DETAILED DESCRIPTION

The technical solutions in the embodiment of the present disclosure are further described clearly and completely below in combination with the accompanying drawings. Obviously, the embodiment described is only some, rather than all embodiments of the present disclosure. Based on the embodiment of the present disclosure, all other embodiments obtained by those ordinary skilled in the art without creative efforts fall within the scope of protection of the present disclosure.

The embodiments of the present disclosure are described in detail below in combination with the accompanying drawings through specific embodiments and application scenarios thereof.

In the existing wave absorption techniques, a passive wave absorption device often needs to occupy a large space, and needs regular maintenance according to the usage of wave absorption device, thereby increasing costs. Moreover, due to a wide distribution of long-wave energy, it is difficult for a single-structure wave absorption device to effectively attenuate its energy, resulting in poor absorption effect for long-period waves. There are certain limitations. Quasi-three-dimensional active absorption technique assumes that a reflection wave angle is a known and fixed angle, and its design mainly focuses on compensating for reflected waves at a single angle, which makes it difficult to handle complex multi-angle reflected wave fields, resulting in lower real-time performance and making it difficult to achieve accurate experimental simulations. In response to these problems, the present disclosure provides an active wave absorption device for wave maker paddles in a large-scale experimental basin, which assumes that the direction of the reflected waves is unknown and not fixed, with multi-angular components. By placing laser wave height meters on the board, and alternately placing ultrasonic wave height meters in front and back at a front of the board, the direction of reflected waves is detected in real time, and the displacement of the wave maker paddles is corrected in real time to generate compensation waves, which can handle complex multi-angle reflected wave fields, realizing full three-dimensional active wave absorption, while ensuring the stability and real-time performance of the wave absorption process.

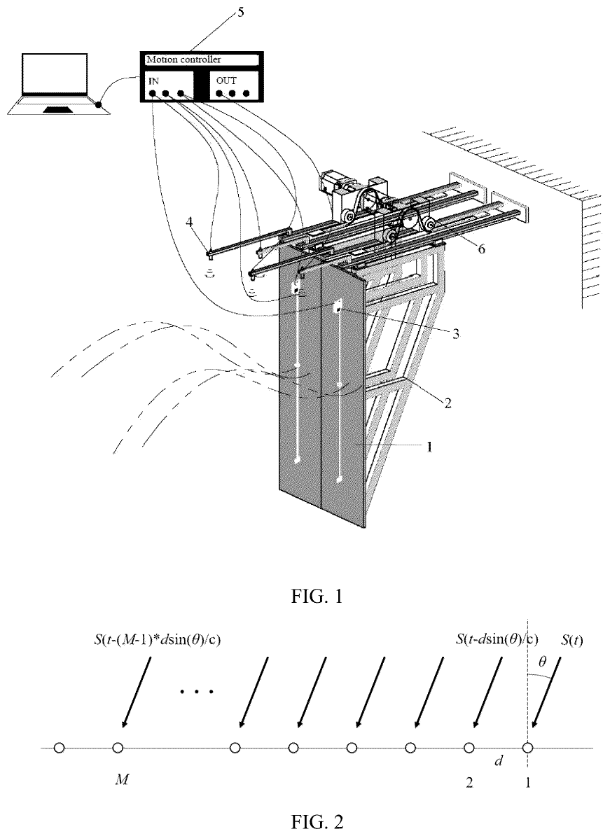

Referring to FIG. 1, in some embodiments of the present disclosure, the active wave absorption device for a wave maker paddle in a large-scale experimental basin includes wave maker paddles 1, push board mounting frames 2, laser sensors 3, ultrasonic sensor 4, a motion controller 5, synchronous belt drive assemblies 6 and drive piece mounting frames.

In the above embodiment, the drive piece mounting frame is horizontally arranged, one end is fixed to a wall of an experimental basin, and the other end is in a free state. The synchronous belt drive assembly 6 is arranged on the drive piece mounting frame and connected to the motion controller 5; the push board mounting frame 2 is arranged below the drive piece mounting frame and fixedly connected to the synchronous belt drive assembly 6; when the synchronous belt drive assembly 6 operates under the control of the motion controller 5, it drives the push board mounting frame 2 to realize horizontal movement; and the wave maker paddle 1 is fixed to a front end of the push board mounting frame 2, and moves with the motion of the push board mounting frame 2 as well, and the motion of the wave maker paddle 1 pushes the movement of water, thereby realizing wave generation.

In some embodiments of the present disclosure, the active wave absorption device for wave maker paddles in a large-scale experimental basin further includes an upper computer, and the upper computer is connected to the motion controller 5. When the active wave absorption device operates, wave parameters are set by the upper computer, and an excitation signal is formed and transmitted to the motion controller 5 based on the calculation and processing of the parameters. The motion controller 5 controls the synchronous belt drive assembly 6 to perform corresponding actions according to the excitation signal. The servo motor in the synchronous belt drive assembly 6 receives a motion instruction from a programmable logic controller (PLC) program running in the corresponding motion controller, and returns the motion state signal of the servo motor.

In some embodiments of the present disclosure, the synchronous belt drive assembly 6 includes a servo motor, a driving wheel, a driven wheel, and a synchronous belt with connecting teeth arranged on an inner side. A motor shaft of the servo motor is fixedly connected to the driving wheel, one end of the synchronous belt is meshed with the driving wheel, and the other end is meshed with the driven wheel; and the driving wheel rotates, driving the synchronous belt and the driven wheel to rotate. The rotation of the synchronous belt causes displacement at various positions on the belt. Since the push board mounting frame 2 is fixedly connected to the synchronous belt, the push board mounting frame 2 is driven to realize the displacement, effectively converting the rotation of the servo motor into the front-and-back motion of the push board mounting frame. There may be a plurality of groups of synchronous belt drive assemblies 6, and each group of synchronous belt drive assemblies corresponds to a wave maker paddle.

In some embodiments of the present disclosure, the push board mounting frame 2 is a triangular stainless steel truss, guide rail sliding blocks are arranged at a top of the triangular stainless steel truss, a corresponding horizontal guide rail is arranged on a lower surface of the drive piece mounting frame, and the guide rail sliding blocks are slidably connected to the guide rail, for bearing the weight of a board surface and a mounting frame, and causing the board to slide forward and backward freely. When the push board mounting frame 2 is driven to displace back and forth, the wave maker paddle 1 connected to the push board mounting frame 2 moves back and forth with the mounting frame, generating push-pull forces on water to achieve wave generation.

The quantity of wave maker paddle 1 is two or more, and each wave maker paddle simultaneously generates a traveling wave (a wave with the target wave height and period) and a compensation wave (a wave that cancels out secondary reflections). Therefore, the movement of the wave maker paddles is a superposition of wave generation motion and active absorption motion. More than two wave maker paddles can realize oblique wave generation by utilizing phase differences between the boards, achieving three-dimensional effect.

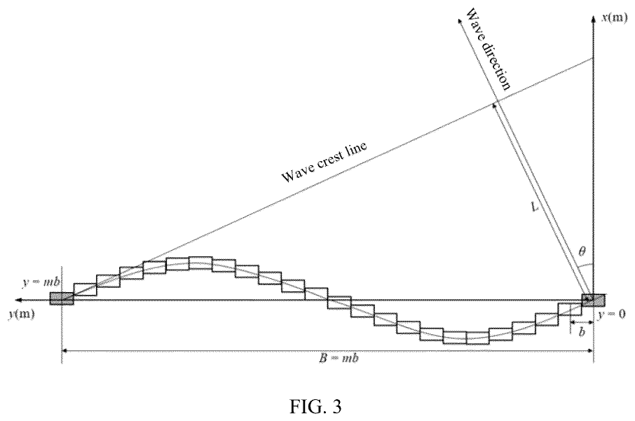

Three-dimensional wave generation is a multi-board cooperative process. In a schematic diagram of a multi-board oblique wave generation shown in FIG. 3, oblique wave generation at a direction angle of θ can be performed when a motion phase difference between boards Δφ and the direction angle θ satisfy a formula (1), in which a wave time is T, a wave length is L, the wave maker paddles are arranged along a y-direction, a normal direction of a wave generation boundary is an x-direction, a width of single board is b, a total number of boards is m, and k₀ is a wave number of traveling wave.

$$Δφ = {k}_{0} b sin θ \qquad ( 1 )$$

In some embodiments of the present disclosure, the laser sensor 3 is arranged at an upper portion of a front surface of the wave maker paddle, and at least one laser sensor 3 is arranged on each wave maker paddle. The ultrasonic sensor 4 is fixedly arranged at a front and upper portion of the wave maker paddle in a forward extension direction, and the forward extension direction may extend forward along the drive piece mounting frame. The plurality of ultrasonic sensors 4 extend forward by different lengths, ensuring that the ultrasonic sensors 4 are arranged in an alternating configuration.

In the process of theoretical derivation, active absorption method is divided into time-domain algorithm and frequency-domain algorithm according to different solution domains. The algorithms of the two domains are combined to determine a control mode of the wave maker paddles.

### Time-Domain Algorithm:

The motion displacements of the wave maker paddles includes a displacement value of the wave maker paddle generating a traveling wave x_{gen}(t) and a displacement value of the wave maker paddle generating a compensation wave x_{abs}(t).

$${x}_{a} ( t ) = {x}_{gen} ( t ) + {x}_{abs} ( t ) = {X}_{mg} sin ( ω t - ky sin θ ) + {X}_{ma} sin ( ω t - ky sin θ + ϕ ) \qquad ( 2 )$$

where X_{mg} and Xₘₐ are strokes of the wave maker paddle for pure wave generation and compensating wave generation, ω is an angular frequency, k is a wave number under this water depth for the wave time T, y is a center position coordinate of the wave maker paddle, and θ is a wave direction angle.

Take a wave elevation on the wave maker paddle in a quasi-three-dimensional active absorption wave generation basin as η₀(t), which can be expressed as:

$${η}_{0} ( t ) = {η}_{p} ( t ) + {η}_{p}^{e} ( t ) + {η}_{r} ( t ) + {η}_{rr} ( t ) + {\tilde{η}}_{rr} ( t ) + {\tilde{η}}_{rr}^{e} ( t ) \qquad ( 3 )$$

where ηₚ(t) is a target traveling wave height,

$${η}_{p}^{e} ( t )$$

is a gumiawu non-propagaung modal wave height corresponding to the target traveling wave height, ηᵣ(t) is a wave height of a primary reflected wave, ηᵣᵣ(t) is a wave height of a secondary reflected wave, ñᵣᵣ(t) is a compensation wave height generated by a wave maker paddle motion x_{abs}(t) for active absorption, and its absolute value is the same as ηᵣᵣ(t), with a phase difference being 180°, and

$${\tilde{η}}_{rr}^{e} ( t )$$

is a non-modal wave neignt corresponding to this process. When a secondary reflection coefficient is 100%, ηᵣ(t)=ηᵣᵣ(t). Moreover, according to a linear wave generation theory:

$$\{ \begin{matrix}{η}_{p} ( t ) = {e}_{0} {x}_{gen} ( t ) \\ {η}_{p}^{σ} ( t ) = {\sum }_{n = 1}^{N} {e}_{n} {x}_{gen} ( t ) \\ {\tilde{η}}_{rr} ( t ) = {e}_{0} {x}_{abx} ( t ) = - {η}_{rr} ( t ) = - {η}_{r} ( t ) \\ {\tilde{η}}_{rr}^{e} ( t ) = {\sum }_{n = 1}^{N} {e}_{n} {x}_{abx} ( t )\end{matrix} \qquad ( 4 )$$

where e₀ and eₙ represent three-dimensional hydrodynamic transfer functions of the traveling wave and non-propagating modal term, denoted as:

$$\{ \begin{matrix}{e}_{0} = \frac{{k}_{0}^{2}}{\sqrt{{k}_{0}^{2} - {k}_{y}^{2}}} {c}_{0} = \frac{1}{cos θ} {c}_{0} \\ {e}_{n} = \frac{{k}_{n}^{2}}{\sqrt{{k}_{n}^{2} - {k}_{y}^{2}}} {c}_{n} = \frac{{k}_{n}^{2}}{\sqrt{{k}_{n}^{2} - {k}_{0}^{2} {sin}^{2} θ}} {c}_{n}\end{matrix} , n = 1 , 2 , \qquad ( 5 )$$

The governing equation of active absorption under the time domain can be obtained by transforming the above formula with the linear wave generation theory, in which m represents a moment of m, and x represents a real-time displacement value of the wave maker paddles:

$$\{ \begin{matrix}Δ x = \frac{ω}{{e}_{0}} \{ 2 {η}_{p} ( m ) - {η}_{0} ( m ) + {\sum }_{n = 1}^{N} {e}_{n} {x}_{a} ( m ) \} \cdot Δ t \\ x ( m + 1 ) = x ( m ) + Δ x\end{matrix} \qquad ( 6 )$$

### Frequency-Domain Algorithm:

When a wave maker machine turns on an active absorption mode, the motion of the wave maker can be regarded as a superposition of pure wave generation motion and compensated wave generation motion, that is, a frequency domain complex amplitude X of the wave maker motion can be expressed as:

$$X = {X}_{a}^{abs} + {X}_{a}^{gen} = \{ 2 ( {A}_{p , 0} - {A}_{p}^{e} ) - {A}_{0} \} F = ( 2 {A}_{p} - {A}_{0} ) F \qquad ( 7 )$$

where

$${X}_{a}^{abs} and {X}_{a}^{gen}$$

are frequently domain complex amplitudes of a displacement value of the wave maker under the pure wave generation and a displacement value of the wave maker corresponding to the generated compensation wave, A_{p,0} is a theoretical frequency domain complex amplitude of the target wave height in front of the boards calculated by the linear wave generation theory, F is a frequency domain transfer function of active absorption wave generation, which is related to the three-dimensional hydrodynamic transfer functions of e₀ and eₙ.

$${A}_{0} = {A}_{p} + {A}_{p}^{e} + {A}_{r} + {A}_{rr} + {\tilde{A}}_{rr} + {\tilde{A}}_{rr}^{e} \qquad ( 8 )$$

$$\{ \begin{matrix}{A}_{p} = {je}_{0} {X}_{a}^{gen} \\ {A}_{p}^{e} = {\sum }_{n = 1}^{N} {e}_{n} {X}_{a}^{gen} \\ {\tilde{A}}_{rr} = {je}_{0} {X}_{a}^{abs} \\ {\tilde{A}}_{rr}^{e} = {\sum }_{n = 1}^{N} {e}_{n} {X}_{a}^{abs} \\ {A}_{r} = {A}_{rr} = - {\tilde{A}}_{rr}\end{matrix} \qquad ( 9 )$$

$$F = \frac{1}{{je}_{0} - {\sum }_{n = 1}^{N} {e}_{n}} \qquad ( 10 )$$

A formula can be obtained through inverse Fourier transform:

$${x}_{a} = ( 2 {η}_{p} - {η}_{0} ) F \qquad ( 11 )$$

In digital signal processing, a formula (11) can be viewed as a single-input single-output (SISO) discrete linear time-invariant (LTI) system where an input is a wave height signal and an output is a displacement signal of the wave maker paddles. By constructing the active absorption frequency transfer function F corresponding to a linear constant coefficient difference equation, a formula (12) represents a typical form of such a difference equation.

$$y ( t ) = {\sum }_{m = 0}^{M} {b}_{m} x [ t - m ] - {\sum }_{n = 1}^{N} {a}_{n} y [ t - n ] \qquad ( 12 )$$

where y and x are an output signal and an input signal, aₙ and bₘ are filter coefficients to determine a relationship between the input signal and output signal, further serving as design parameters of a frequency-domain filter corresponding to the difference equation. These coefficients are derived by fitting the frequency-domain transfer function of F to a filter.

According to the above active absorption theory, it is necessary to obtain wave parameter information as control signals to participate in the calculation of active absorption algorithm for achieving active absorption function in a wave generation system. Therefore, it is necessary to deploy wave height sensors for real-time data acquisition. To avoid interference from strong electric environments and control experimental costs, a form is adopted that the laser sensors 3 are arranged on the wave maker paddles, while the ultrasonic sensors 4 are alternately arranged in front of the wave maker paddles, thereby enhancing the accuracy of wave surface measurements and ensuring real-time acquisition of wave profile signals. The primary acquisition focuses on the wave height at the wave maker paddles, denoted as no (t). Based on the above derivation process, the displacement increment of the wave maker paddles is calculated.

### Direction Angle Algorithm:

Assume a signal acquisition array (the ultrasonic sensor 4) is a linearly arranged array consisting of M elements with an inter-element spacing of d, as shown in FIG. 2. In this scenario, a signal source that transmits a single-frequency signal is located at a distant azimuth angle. Based on geometric relationships, the signal measured by each array element can be expressed as:

$$S ( t , M ) = {S}_{0} {e}^{j ( ω ( t - \frac{( M - 1 ) dsin ( θ )}{c} ) + φ )} \qquad ( 13 )$$

where S₀ is an amplitude of the signal, ω is a frequency of the signal, φ is an initial phase of the signal, which is theoretically a complex signal, t refers to a current moment, and j refers to an imaginary unit. During the algorithm derivation process, it is assumed that an included angle between a signal direction and a normal line of a sensor array is θ, and a signal propagation speed is c. Let a steering vector a(θ) based on the DOA of θ be defined as:

$$α ( θ ) = {[ 1 , {e}^{- j ω \frac{dsin ( θ )}{c}} , ... , {e}^{- j ω ( M - 1 ) \frac{dsin ( θ )}{c}} ]}^{T} \qquad ( 14 )$$

A signal X(t) measured by each array element can be expressed as a product of a source signal S(t) and the steering vector a(θ). In practical scenarios, the source signal may be superimposed by multiple signals, with each signal component potentially originating from distinct DOA angles. Additionally, the influence of noise needs to be considered in real-world applications.

Under these conditions, the data collected by the array is represented in complex form, containing information such as the amplitude, frequency, and DOA of each source signal component. The data can be regarded as the superposition of multiple spatial harmonic signals. Therefore, a spatial spectrum analysis can be introduced, defining a spatial spectral function P(θ) as:

$$P ( θ ) = \frac{1}{{α}^{H} ( θ ) {E}_{N} {E}_{N}^{H} α ( θ )} \qquad ( 15 )$$

where α(θ) is a vector based on the DOA of θ, α^{H}(θ) and

$${E}_{N}^{H}$$

are conjugate transpose matrixes of a(θ) and E_{N}, and E_{N} is a constructed pseudo-noise matrix. After substituting each angle into this formula, values of spectral function are calculated, and peaks of the spectral function after scanning correspond to the DOA angles.

During the active absorption process, the above real-time direction angle detection algorithm is applied to process data collected by the ultrasonic sensors 4 in front of the wave maker paddles, ensuring real-time calculation of a dominant direction of a reflected wave field. Furthermore, the wave height signal is acquired in real-time by the laser sensors 3 on the wave maker paddles. The computed wave height and angle information are fed back to the motion controller 5. Based on sensor-derived wave signals and current positions of the wave maker paddles, the active absorption algorithm is employed to output the displacement increment of the wave maker paddles at the current moment. By adjusting the motion pattern of wave maker paddles 1 and utilizing phase differences among multiple wave maker paddles, oblique wave generation can be achieved, ensuring real-time generation of compensatory waves, and ultimately realizing full three-dimensional active absorption wave generation.

Compared to the related art, the present disclosure mainly includes the following beneficial effects.
1. Existing passive wave absorption devices require a certain amount of basin space, which affects the actual use area of the basin and limits the actual utilization efficiency of the basin. In the present disclosure, an active wave absorption device is employed, requires no significant additional basin space and features a compact arrangement of wave maker paddles and sensors, thereby enhancing the actual utilization efficiency of the basin.
2. Existing passive wave absorption structures may be affected by waves, currents and corrosion during use, requiring regular maintenance and replacement, thereby increasing operating costs. In the present disclosure, the laser sensors and the ultrasonic sensors are employed for real-time data acquisition, reducing wear and corrosion risks of mechanical structures and lowering maintenance costs.
3. Existing wave absorption devices usually employ a single structural form, leading to a poor wave absorption effect when dealing with long-period waves and high-energy waves. In contrast, the present disclosure can effectively handle waves of varying frequencies and energies by integrating time-domain and frequency-domain algorithms with the introduction of a direction angle algorithm, enhancing wave absorption performance.
4. Existing quasi-three-dimensional active absorption techniques assume that reflected wave angles are known and fixed, making it difficult to handle complex multi-angle reflected wave fields, and resulting in low real-time performance. In the present disclosure, reflected wave directions are calculated in real-time, combined with real-time data acquisition from the laser sensors and the ultrasonic sensors, ensuring the dynamical adjustment of the displacement increments of wave maker paddles, thereby enhancing the system's real-time performance and adaptability.
5. Existing quasi-three-dimensional active absorption techniques can only compensate for single-angle reflected waves, making it difficult to handle complex multi-angle reflection wave fields. In the present disclosure, motion phase differences of a plurality of wave maker paddles are utilized to achieve oblique wave generation, generate compensation waves, and ultimately realize full three-dimensional active absorption wave generation, thereby handling complex multi-angle reflected wave fields.

Portions of the present disclosure not explicitly described may refer to the related art in the field or constitute common technical knowledge to a person skilled in the art, and are not redundantly elaborated herein.

The embodiments of the present disclosure have been described above with reference to the accompanying drawings, the present disclosure is not limited to the above specific implementations. These implementations are merely illustrative rather than restrictive. A person skilled in the art, guided by the principles of the present disclosure and without departing from inventive essence or the scope of the present disclosure defined by the claims, may derive multiple variations, all of which shall fall within the scope of the protection of the present disclosure.

1. An active wave absorption device for wave maker paddles in a large-scale experimental basin, comprising wave maker paddles (1), push board mounting frames (2), a motion controller (5), synchronous belt drive assemblies (6) and drive piece mounting frames, wherein
the drive piece mounting frame is horizontally arranged, one end is fixed to a wall of an experimental basin, and the other end is in a free state; and the synchronous belt drive assembly (6) is arranged on the drive piece mounting frame and connected to the motion controller (5); and
the push board mounting frame (2) is arranged below the drive piece mounting frame and fixedly connected to the synchronous belt drive assembly (6); when the synchronous belt drive assembly (6) operates under the control of the motion controller (5), it drives the push board mounting frame (2) to realize horizontal movement; and the wave maker paddle (1) is fixed to a front end of the push board mounting frame (2), and moves with the push board mounting frame (2), realizing wave absorption and generation.

2. The active wave absorption device for wave maker paddles in a large-scale experimental basin according to claim 1, wherein the device further comprises a plurality of laser sensors (3), a plurality of ultrasonic sensors (4), and an upper computer;
the laser sensor (3) is arranged at an upper portion of a front surface of the wave maker paddle, and at least one laser sensor is arranged on each wave maker paddle;
the ultrasonic sensors (4) are arranged on forward extension lines of the drive piece mounting frames, and the plurality of ultrasonic sensors (4) extend forward by different lengths, ensuring that the ultrasonic sensors (4) are arranged in an alternating configuration; and
the upper computer is connected to the laser sensors (3) and the ultrasonic sensors (4), and used for calculating a governing equation of the wave maker paddles based on information collected by the laser sensors (3) and the ultrasonic sensors (4).

3. The active wave absorption device for wave maker paddles in a large-scale experimental basin according to claim 1, wherein the synchronous belt drive assembly (6) comprises a servo motor, a driving wheel, a driven wheel, and a synchronous belt with connecting teeth arranged on an inner side; and
a motor shaft of the servo motor is fixedly connected to the driving wheel, one end of the synchronous belt is meshed with the driving wheel, and the other end is meshed with the driven wheel; the driving wheel rotates, driving the synchronous belt and the driven wheel to rotate; and the synchronous belt is fixedly connected to the push board mounting frame (2), driving the push board mounting frame (2) to achieve displacement.

4. The active wave absorption device for wave maker paddles in a large-scale experimental basin according to claim 3, wherein guide rail sliding blocks are arranged at a top of the push board mounting frame (2), a corresponding horizontal guide rail is arranged on a lower surface of the drive piece mounting frame, and the guide rail sliding blocks are slidably connected to the guide rail; and when the push board mounting frame (2) is driven to displace back and forth, and the wave maker paddle (1) connected to the push board mounting frame (2) moves back and forth simultaneously, generating push-pull forces on water to achieve wave generation.

5. The active wave absorption device for wave maker paddles in a large-scale experimental basin according to claim 2, wherein the upper computer performs calculation from two domains of time domain and frequency domain based on the information collected by the laser sensors (3) and the ultrasonic sensors (4), to determine a governing equation of the wave maker paddles.

6. The active wave absorption device for wave maker paddles in a large-scale experimental basin according to claim 5, wherein the upper computer is used for calculating a main direction of a reflected wave field by using a direction angle algorithm based on the information collected in real time, and determining the governing equation of the wave maker paddles based on the main direction.

7. The active wave absorption device for wave maker paddles in a large-scale experimental basin according to claim 6, wherein the collected information comprises amplitude, frequency and direction-of-arrival (DOA).

8. The active wave absorption device for wave maker paddles in a large-scale experimental basin according to claim 1, wherein the push board mounting frame (2) is a triangular stainless steel truss.

9. The active wave absorption device for wave maker paddles in a large-scale experimental basin according to claim 4, wherein two guide rail sliding blocks are arranged at a top of each push board mounting frame (2), and matched with two guide rails.

10. An active wave absorption method for wave maker paddles in a large-scale experimental basin, utilizing the active wave absorption device for wave maker paddles in a large-scale experimental basin according to claim 1, comprising the steps of:
performing calculation from two domains of time domain and frequency domain based on information collected by sensors in real time, to determine a governing equation of wave maker paddles, sending real-time control signals to a motion controller (5) based on the governing equation, controlling movements of synchronous belt drive assemblies (6) through the motion controller (5), and driving the corresponding wave maker paddle (1) to move to achieve wave generation.

11. An active wave absorption method for wave maker paddles in a large-scale experimental basin, utilizing the active wave absorption device for wave maker paddles in a large-scale experimental basin according to claim 2, comprising the steps of:
performing calculation from two domains of time domain and frequency domain based on information collected by sensors in real time, to determine a governing equation of wave maker paddles, sending real-time control signals to a motion controller (5) based on the governing equation, controlling movements of synchronous belt drive assemblies (6) through the motion controller (5), and driving the corresponding wave maker paddle (1) to move to achieve wave generation.

12. An active wave absorption method for wave maker paddles in a large-scale experimental basin, utilizing the active wave absorption device for wave maker paddles in a large-scale experimental basin according to claim 3, comprising the steps of:
performing calculation from two domains of time domain and frequency domain based on information collected by sensors in real time, to determine a governing equation of wave maker paddles, sending real-time control signals to a motion controller (5) based on the governing equation, controlling movements of synchronous belt drive assemblies (6) through the motion controller (5), and driving the corresponding wave maker paddle (1) to move to achieve wave generation.

13. An active wave absorption method for wave maker paddles in a large-scale experimental basin, utilizing the active wave absorption device for wave maker paddles in a large-scale experimental basin according to claim 4, comprising the steps of:
performing calculation from two domains of time domain and frequency domain based on information collected by sensors in real time, to determine a governing equation of wave maker paddles, sending real-time control signals to a motion controller (5) based on the governing equation, controlling movements of synchronous belt drive assemblies (6) through the motion controller (5), and driving the corresponding wave maker paddle (1) to move to achieve wave generation.

14. An active wave absorption method for wave maker paddles in a large-scale experimental basin, utilizing the active wave absorption device for wave maker paddles in a large-scale experimental basin according to claim 5, comprising the steps of:
performing calculation from two domains of time domain and frequency domain based on information collected by sensors in real time, to determine a governing equation of wave maker paddles, sending real-time control signals to a motion controller (5) based on the governing equation, controlling movements of synchronous belt drive assemblies (6) through the motion controller (5), and driving the corresponding wave maker paddle (1) to move to achieve wave generation.

15. An active wave absorption method for wave maker paddles in a large-scale experimental basin, utilizing the active wave absorption device for wave maker paddles in a large-scale experimental basin according to claim 6, comprising the steps of:
performing calculation from two domains of time domain and frequency domain based on information collected by sensors in real time, to determine a governing equation of wave maker paddles, sending real-time control signals to a motion controller (5) based on the governing equation, controlling movements of synchronous belt drive assemblies (6) through the motion controller (5), and driving the corresponding wave maker paddle (1) to move to achieve wave generation.

16. An active wave absorption method for wave maker paddles in a large-scale experimental basin, utilizing the active wave absorption device for wave maker paddles in a large-scale experimental basin according to claim 7, comprising the steps of:
performing calculation from two domains of time domain and frequency domain based on information collected by sensors in real time, to determine a governing equation of wave maker paddles, sending real-time control signals to a motion controller (5) based on the governing equation, controlling movements of synchronous belt drive assemblies (6) through the motion controller (5), and driving the corresponding wave maker paddle (1) to move to achieve wave generation.

17. An active wave absorption method for wave maker paddles in a large-scale experimental basin, utilizing the active wave absorption device for wave maker paddles in a large-scale experimental basin according to claim 8, comprising the steps of:
performing calculation from two domains of time domain and frequency domain based on information collected by sensors in real time, to determine a governing equation of wave maker paddles, sending real-time control signals to a motion controller (5) based on the governing equation, controlling movements of synchronous belt drive assemblies (6) through the motion controller (5), and driving the corresponding wave maker paddle (1) to move to achieve wave generation.

18. An active wave absorption method for wave maker paddles in a large-scale experimental basin, utilizing the active wave absorption device for wave maker paddles in a large-scale experimental basin according to claim 9, comprising the steps of:
performing calculation from two domains of time domain and frequency domain based on information collected by sensors in real time, to determine a governing equation of wave maker paddles, sending real-time control signals to a motion controller (5) based on the governing equation, controlling movements of synchronous belt drive assemblies (6) through the motion controller (5), and driving the corresponding wave maker paddle (1) to move to achieve wave generation.
